(19) United States
(12) Patent Application Publication
(10) Pub. No.: US 2026/0227593 A1
(43) Pub. Date: Aug. 6, 2026

(54) CAMERA MODULE AND ELECTRONIC DEVICE COMPRISING SAME

(71) Applicant: LG INNOTEK CO., LTD., Seoul (KR)

(72) Inventors: Sung Min MOON, Seoul (KR); Dae Kyu CHOI, Seoul (KR)

(73) Assignee: LG INNOTEK CO., LTD., Seoul (KR)

(21) Appl. No.: 19/147,619

(22) PCT Filed: Jan. 12, 2024
(86) PCT No.: PCT/KR2024/000659

§ 371 Date: Jul. 11, 2025

(30) Foreign Application Priority Data
Jan. 12, 2023 (KR) 10-2023-0004957

(51) Int. Cl. G02B 7/02

(52) U.S. Cl. CPC G02B 7/021

(57) ABSTRACT

A camera module disclosed in an embodiment of the invention comprises: a reflective member that reflects light incident in a first direction in a second direction; a lens holder having a plurality of lenses aligned along the second direction; a circuit board having an image sensor that converts light refracted through the plurality of lenses into an electrical signal; a plurality of spacers disposed on an outer periphery between two adjacent lenses; and a spacing member having a largest thickness among the plurality of spacers, wherein the spacing member may include a through hole extending from an upper surface to a lower surface and a plurality of reflective patterns arranged in a concentric circle shape along an inner surface of the through hole.

### TECHNICAL FIELD

An invention relates to a camera module and an electronic device including the same.

### BACKGROUND ART

A camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for this camera module to obtain an image is an imaging lens that forms an image. Recently, interest in high efficiency such as high image quality and high resolution is increasing, and research on an optical system including plurality of lenses is being conducted in order to realize this. Camera module having an image sensor such as CCD (Charge coupled device) or CMOS (Complementary metal oxide semiconductor image sensor) has filter (optical filter) with various optical functions between the lens and the image sensor in order to obtain clear images while reproducing color tones well. A representative example of this is an optical filter (near-infrared cut filter) that blocks light in the near-infrared wavelength range in order to correct the spectral sensitivity of the image sensor to human visual sensitivity, and the optical filter is disposed between the last lens and the image sensor. Such a camera module has multiple lenses stacked, and light passing through the multiple lenses may be collected by the image sensor and stored as data in the memory within the device.

However, since flare phenomena such as light spreading can occur due to reflection or scattering of light incident on the camera module, which can adversely affect the image quality, it is necessary to block unnecessary light from proceeding to the image sensor. Therefore, a new camera module that can solve the above-described problem is required.

### DISCLOSURE

### Technical Problem

An embodiment of the invention provides a camera module having a reflective pattern on an inner surface of a spacer between a plurality of lenses. Preferably, the camera module provides in which a ring-shaped reflective pattern is formed on the inner surface of the spacer having the largest thickness.

An embodiment of the invention provides a camera module capable of reducing flare by arranging a reflective pattern between two lenses having the largest gap among the gaps between a plurality of lenses. An embodiment of the invention provides a camera module having a pattern for reflecting, absorbing, or scattering light traveling along an abnormal path among light traveling through a plurality of lenses through a reflective member. An embodiment of the invention can improve the reliability of a folded camera module.

### Technical Solution

A camera module according to an embodiment of the invention comprises: a reflective member that reflects light incident in a first direction in a second direction; a lens holder having a plurality of lenses aligned along the second direction; a circuit board having an image sensor that converts light refracted through the plurality of lenses into an electrical signal; a plurality of spacers disposed on an outer periphery between two adjacent lenses; and a spacing member having a largest thickness among the plurality of spacers, wherein the spacing member may include a through hole extending from an upper surface to a lower surface and a plurality of reflective patterns arranged in a concentric circle shape along an inner surface of the through hole.

According to an embodiment of the invention, the through hole of the spacing member may have an upper portion larger than a lower portion and an inner surface inclined at an angle of 5 degrees or more. A length of the upper portion of the through hole of the spacing member may be CA11, and a length of the lower portion may be CA12, and the following condition may satisfy:

$$0.6 < CA 12 / CA 11 < 0.9 .$$

According to an embodiment of the invention, a plurality of grooves is respectively disposed between the reflective patterns, and a thickness of the spacing member is TO, a depth of the groove is T1, and the following condition may satisfy: 0.03<T1/T0<0.22. A pitch between the reflective patterns is T2, and the following condition may satisfy: 0.04<T2/T0<0.3.

According to an embodiment of the invention, an outer surface of the spacing member may have different lengths in a first direction and a third direction perpendicular to a second direction, which is an optical axis of the plurality of lenses. The thickness of the spacing member is TO, and the following condition may satisfy: 0.3 mm<T0<2.8 mm.

According to an embodiment of the invention, an object-side surface or a sensor-side surface of at least one lens adjacent to an object among the plurality of lenses may have a non-circular shape in which effective lengths in two directions perpendicular to the optical axis of the plurality of lenses are different from each other. A first lens closest to the object among the plurality of lenses includes an object-side surface and a sensor-side surface, and the maximum effective length of the object-side surface is CAlS1y, the minimum effective length is CAlS1x, and the following equation may satisfy: 0.55<CAlS1x/CAlS1y <0.98.

According to an embodiment of the invention, the maximum effective length of the sensor-side surface of the first lens is CAlS2y, the minimum effective length is CAlS2x, and the following equation may satisfy: 0.55<CAlS2x/CAlS2y <0.98.

According to an embodiment of the invention, an outer peripheral surface of the lens holder may include a region in which two directions perpendicular to the optical axis have different lengths. The sensor-side surface of a lens located on the object side of the spacing member may have a circular shape.

A mobile terminal or an electronic device according to an embodiment of the invention may include the camera module disclosed above.

### Advantageous Effects

According to an embodiment of the invention, there is an effect that a pattern is arranged on the inside of a camera module to disperse light traveling in an abnormal path, thereby reducing the intensity of flare.

According to an embodiment of the invention, a pattern is formed on the inside of a spacer or a spacing member between lenses, so that light transmitted to an image sensor through the inside can be reflected, scattered, or absorbed, thereby minimizing the occurrence of a flare phenomenon. The invention can improve the reliability of a folded camera module. The invention can improve the reliability of a camera module with improved reliability and an electronic device having a portable terminal, an unmanned or manned vehicle (a vehicle, a drone, a bike, a watercraft) having the same.

### DESCRIPTION OF DRAWINGS

FIG. 1 is a perspective view of a camera module according to an embodiment.

FIG. 2 is a side cross-sectional view of the camera module of FIG. 1.

FIG. 3 is an exploded perspective view of a second lens assembly in the camera module of FIG. 2.

FIG. 4 is a plan view of lenses of the second lens assembly of FIG. 2, the lengths of which are different in the first and second directions perpendicular to the optical axis.

FIG. 5 is a partial enlarged view of the second lens assembly of FIG. 2.

FIG. 6 (A)(B) is a side cross-sectional view and an enlarged view of part A of the spacing member of FIG. 2.

FIG. 7 (A)(B) is an example of a perspective view and a side cross-sectional view of the spacing member of FIG. 2.

FIG. 8 (A)(B) is a first modified example of a perspective view and a side cross-sectional view of the spacing member of FIG. 2.

FIG. 9 (A)(B) is a second modified example of the perspective view and side cross-sectional view of the spacing member of FIG. 2.

FIG. 10 (A)(B) is a third modified example of the perspective view and side cross-sectional view of the spacing member of FIG. 2.

FIG. 11 (A)(B) is a fourth modified example of the perspective view and side cross-sectional view of the spacing member of FIG. 2.

FIG. 12 (A)(B) is a drawing comparing the flare intensity incident on the image sensor according to the comparative example and the embodiment.

FIG. 13 is a perspective view of a mobile terminal to which a camera module according to the embodiment is applied.

FIG. 14 is a perspective view of a vehicle to which a camera module according to the embodiment is applied.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the specification, the first lens means the lens closest to the object, and the last lens means the lens closest to the image surface (or image sensor). In this specification, the units of the curvature radius, thickness, TTL, ImgH (height of the image surface: 1/2 of the diagonal length of the image surface), and focal length of the lens are all in mm. In addition, the thickness of the lens, the gap between the lenses, and TTL are distances from the optical axis of the lens. In addition, in the description of the shape of the lens, the meaning of a convex shape on one side means that the optical axis portion of the corresponding surface is convex, and the meaning of a concave shape on one side means that the optical axis portion of the corresponding surface is concave. Therefore, even if one side of the lens is described as having a convex shape, the edge portion of the lens may be concave. Similarly, even if one side of the lens is described as having a concave shape, the edge portion of the lens may be convex.

The optical system includes an optical system composed of a plurality of lenses. For example, the optical system is composed of a plurality of lenses having refractive power. The optical system may include a plurality of lenses having refractive power, a prism that refracts incident light, and an aperture stop for controlling the amount of light.

In addition, the optical system may have an optical filter for blocking infrared rays, and the optical filter may include an infrared blocking filter. In addition, the optical system may further include an image sensor for converting an image of an object incident through the optical system into an electric signal. In addition, the optical system may further include a gap-maintaining member for adjusting a distance between the lenses. The plurality of lenses is made of a material having a different refractive index from air. For example, the plurality of lenses is made of a plastic or glass material. At least one of the plurality of lenses has an aspherical shape.

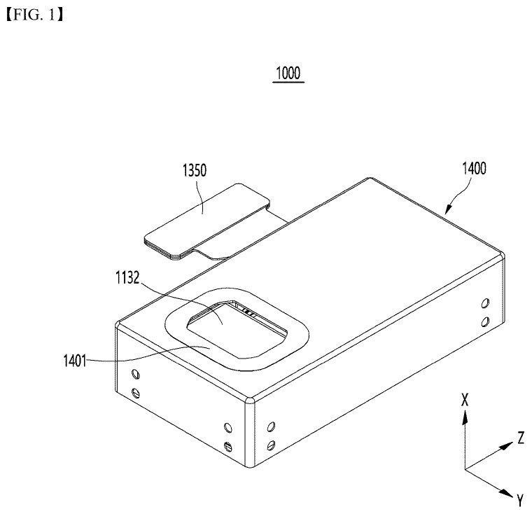

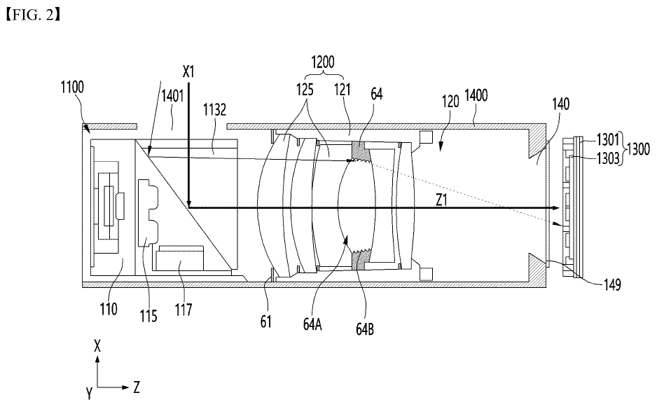

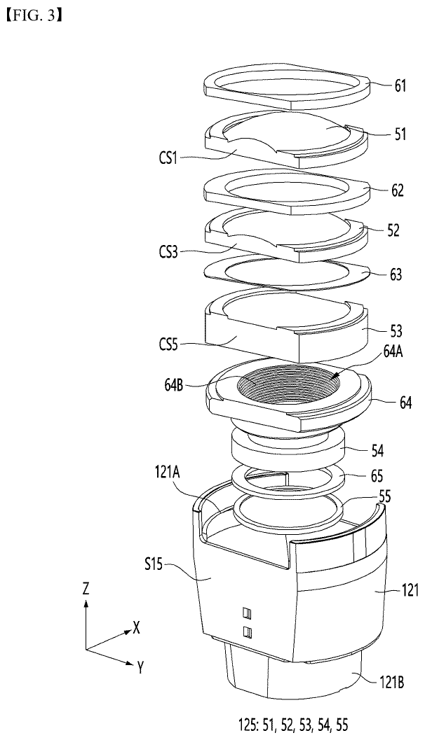

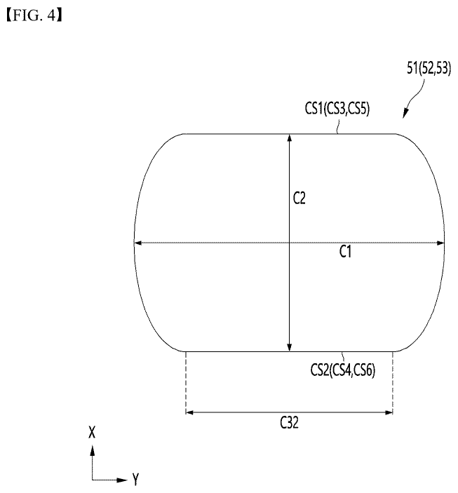

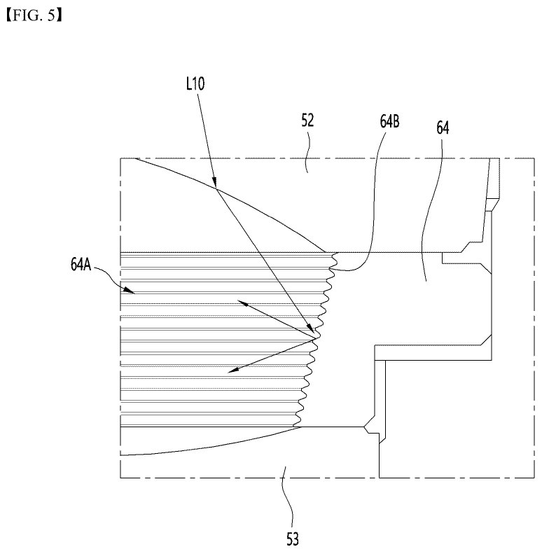

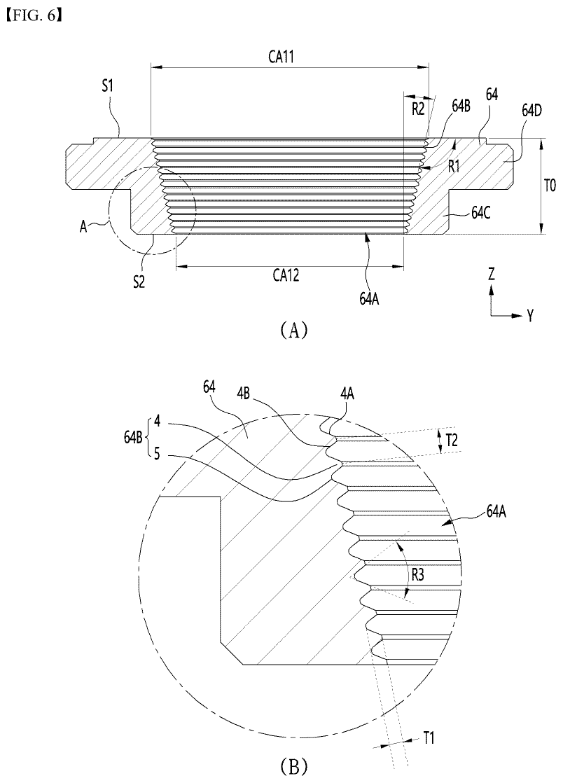

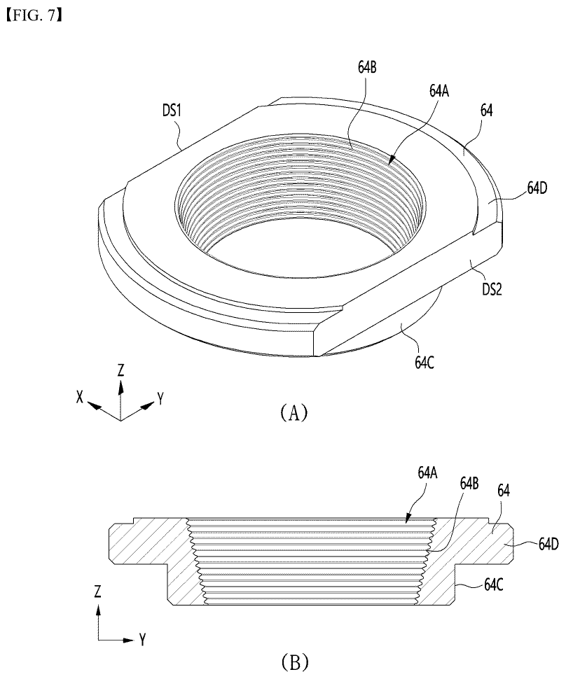

FIG. 1 is a perspective view of a camera module according to an embodiment, FIG. 2 is a side cross-sectional view of the camera module of FIG. 1, FIG. 3 is an exploded perspective view of a second lens assembly in the camera module of FIG. 2, FIG. 4 is a plan view of lenses of the second lens assembly of FIG. 2 having different lengths in first and second directions perpendicular to the optical axis, FIG. 5 is a partial enlarged view of the second lens assembly of FIG. 2, FIG. 6 (A)(B) is side cross-sectional views and an enlarged view of part A of a spacing member of FIG. 2, and FIG. 7 (A)(B) (C) is examples of perspective views of the spacing member of FIG. 2 and side cross-sectional views in the first and second axes.

Referring to FIGS. 1 to 5, a camera module 1000 according to an embodiment may include a housing 1400, a lens assembly 1100, a second lens assembly 1200, and a circuit board 1300. Here, the first lens assembly 1100 can be used as the first actuator, and the second lens assembly 1200 can be used as the second actuator.

The housing 1400 may cover the first lens assembly 1100 and the second lens assembly 1200. A coupling force between the first lens assembly 1100 and the second lens assembly 1200 may be improved by the housing 1400. The housing 1400 may be made of a material that blocks electromagnetic waves. The housing 1400 may be made of a metal material. Accordingly, the first lens assembly 1100 and the second lens assembly 1200 within the housing 1400 may be easily protected. The housing 1400 has a first opening 1401 open on the upper surface, and the first opening 1401 is a region where light is incident on the first lens assembly 1100. The first opening 1401 may overlap the first lens assembly 1100 in a vertical direction X.

The housing 1400 has a second opening 140 on the sensor side, and a shield can (not shown) connected to the circuit board 1300 may be disposed in the second opening 140. The housing 1400 may include a first axis X1 passing through the first opening 1401 and a second axis Z1 passing through the second opening 140, and the first and second axes X1 and Z1 may be orthogonal to each other.

And the first lens assembly 1100 may be an OIS (Optical Image Stabilizer) actuator. For example, the first lens assembly 1100 may move a reflective member in a direction perpendicular to an optical axis (axis of incident light).

The first lens assembly 1100 may include a fixed focal length lens arranged in a predetermined barrel (not shown). The fixed focal length lens may be defined as a single focal length lens or a single-layer lens. The first lens assembly 1100 may change the path of light. In an embodiment, the first lens assembly 1100 may vertically change the path of light incident through a reflective member 1132 therein. The reflective member 1132 may be, for example, a prism or a mirror. For example, the reflective member 1132 may change light from a first direction X to a second direction Z. Alternatively, the reflective member 1132 may change the light from the first axis X1 to the second axis Z1. By this configuration, even if the thickness of the mobile terminal in the first direction X is reduced, a lens configuration larger than the thickness of the mobile terminal may be disposed inside the mobile terminal through the change of the light path, so that magnification, auto-focusing (AF), zoom, and OIS functions may be performed. However, it is not limited thereto, and the first lens assembly 1100 may move the light path in a plurality of vertical directions or tilt at a predetermined angle.

The first lens assembly 1100 may include a first carrier 110, a mover 112, a driving portion 117, and a tilt guide portion 115. The mover 112 includes a reflective member 1132 on the upper portion, and the reflective member 1132 may reflect the incident light in the direction of the second axis Z1. The reflective member 1132 may be formed of a mirror or a prism. The following illustration is based on a prism, but may also be formed of a plurality of lenses as in the above-described embodiment. As another example, the additional reflective member may be formed of a prism or a mirror arranged at the rear of a plurality of lenses 125. In addition, the reflective member 1132 may include a reflective portion disposed inside.

The reflective member 1132 and the mover 112 may be tilted along the tilt guide member 115 by the driving member 117. The driving member 117 is illustrated as being located at the bottom of the mover 112, but may also be arranged on both sides of the mover 112. The driving portion 117 may include a plurality of rotors (not shown) disposed on the bottom and both sides of the mover 112 and a stator (not shown) at a position corresponding to the plurality of rotors. The rotors may be magnets, and the stators may be coils. The driving portion 117 may have a yoke and a hall sensor respectively arranged on the outside of each stator. The first lens assembly 1100 may perform an OIS function. The second lens assembly 1200 may perform a zooming function and an AF function. The configuration of the driving portion of the second lens assembly 1200 will be omitted.

The second lens assembly 1200 may be disposed at the rear end of the first lens assembly 1100. Here, the rear end of the first lens assembly 1100 is a region adjacent to the image sensor 1303. The second lens assembly 1200 may be disposed between the first lens assembly 1100 and the image sensor 1303, and may be coupled with the first lens assembly 1100. And the coupling therebetween may be performed in various ways. The second lens assembly 1200 may be a zoom actuator or an AF (Auto Focus) actuator. For example, the second lens assembly 1200 may include one or a plurality of lenses 125, and may perform an auto focusing function or a zoom function by moving at least one lens according to a control signal of a predetermined control unit. And the one or a plurality of lenses 125 may move independently or individually along the optical axis direction. The optical axes of the plurality of lenses 125 of the second lens assembly 1200 may be the second axis Z1.

The second lens assembly 1200 may include a plurality of lenses 125 and a lens holder 121. The second lens assembly 1200 may be disposed inside the housing 1400. The second lens assembly 1200 may be disposed between the first lens assembly 1100 and the sensor assembly 1300. As another example, a third lens assembly may be further disposed between the second lens assembly 1200 and the sensor assembly 1300, and the third lens assembly may be a reflective prism. The second lens assembly 1200 may have a plurality of lenses 125 stacked along the second direction Z. The plurality of lenses 125 may be three or more, for example, in a range of three to seven or in a range of four to six. The plurality of lenses 125 may have a fixed zoom optical system. In this case, the lens 125 may be fixedly coupled to a fixed position inside the lens holder 121 and may not move in the optical axis direction. As another example, the lens holder 121 may support the plurality of lenses 125 and may support movement of at least one lens in the optical axis direction. Here, when at least one lens among the plurality of lenses 125 moves in the optical axis direction, the lens holder 121 may be separated into a fixed holder and a moving holder.

As shown in FIG. 3, the maximum length of the lens holder 121 in the first direction X and the maximum length in the third direction Y may be different from each other. The maximum length of the lens holder 121 in the first direction may be smaller than the maximum length in the third direction Y. The third direction Y is a direction orthogonal to the first and second directions X and Z. Among the outer regions of the lens holder 121, the maximum lengths of the first and third directions X and Y of the region adjacent to the first lens assembly 1100 may be different from each other.

As shown in FIGS. 3 and 4, among the plurality of lenses 125, at least one lens may have different lengths in the first direction X and the third direction Y. The first and third directions X and Y are directions orthogonal to the optical axes of the lenses. For example, among the lenses, the lenses having different lengths in two directions orthogonal to the optical axis may be one, two, or three lenses adjacent to the object or the reflective member 1132 among the plurality of lenses 125. Here, the expression that the lengths in the two directions orthogonal to the optical axis are different means that the lengths in the two directions of the object-side surface and/or the sensor-side surface of each lens are different. The maximum length C2 of the first lens 51 in the first direction X may be smaller than the maximum length C1 of the third direction Y. The first lens 51 may have a non-circular shape. The maximum length C2 of the second lens 52 in the first direction X may be smaller than the maximum length C1 of the third direction Y. The second lens 52 may have a non-circular shape. The maximum length C2 of the third lens 53 in the first direction X may be smaller than the maximum length C1 of the third direction Y. The third lens 53 may have a non-circular shape.

One, two, or all of the first to third lenses 51, 52, and 53 may have non-circular shapes. At least one or more of the first to third lenses 51, 52, and 53 are arranged so that the maximum length C2 in the first direction X is smaller than the maximum length C1 in the third direction Y, and the maximum length of the lens holder 121 in the first direction X is smaller than the maximum length in the third direction Y, so that the height of the lens holder 121 in the third direction Y can be lowered, and the height or thickness of the camera module 1000 in the third direction Y may be lowered. Accordingly, the thickness or height of the mobile terminal or electronic device having the camera module 1000 in the third direction Y may be lowered, and the thickness of the terminal or electronic device can be provided slimly.

The maximum length in the first direction and the maximum length in the third direction of the fourth lens 54 may be the same. The fourth lens 54 may be a circular lens. That is, the object-side surface or the sensor-side surface of the fourth lens 54 is circular in shape. The maximum length in the first direction and the maximum length in the third direction of the fifth lens 55 may be the same. The fifth lens 55 may be a circular lens. That is, the object-side surface or the sensor-side surface of the fifth lens 55 is circular in shape.

At least one of the first to third lenses 51, 52, and 53 may be provided with one or both sides in the first direction X as a flat surface. For example, one or both sides in the first direction X of the first lens 51 may be provided as a flat surface, and both sides in the third direction Y may be provided as a convex surface. One or both sides in the first direction X of the second lens 52 may be provided as a flat surface, and both sides in the third direction Y may be provided as a convex surface. One side or both sides of the first direction X of the third lens 53 may be provided as a flat surface, and both sides of the third direction Y may be provided as a convex curved surface. Here, if the difference in the effective diameter of the sensor-side surface of the third lens 53 is large, the sensor-side surface of the third lens 53 may be provided as a circular shape. As another example, the sensor-side surface of the third lens 53 may have a non-circular shape in which the lengths in the first and third directions are different, as in the above condition. At least one of the first to third lenses 51, 52, and 53 may have flat or cut surfaces CSI to CS6 on both sides, and the length C32 of the cut surface in the third direction Y may be smaller than the length C1 of the third direction Y passing through the center of the optical axis.

If the maximum effective length of the object-side surface of the first lens 51 is CAlS1y and the minimum effective length is CAlS1x, then the condition of the following equation may satisfy: 0.55<CAlS1x/CAlS1y <0.98. Here, if the value of the equation is less than 0.55, it is difficult to manufacture the object-side surface of the first lens 51 into a non-circular shape and it is difficult to control the distribution of the incident light, and if it exceeds 0.98, the size reduction in the third axis direction of the optical system may be minimal. If the maximum effective length of the sensor-side surface of the first lens 51 is CAlS2y and the minimum effective length is CAlS2x, then the condition of the following equation may satisfy: 0.55<CAlS2x/CAlS2y <0.98. Here, if the value of the equation is less than 0.55, it is difficult to manufacture the sensor-side surface of the first lens 51 as a non-circular shape and it is difficult to control the distribution of the incident light, and if it exceeds 0.98, the size reduction in the third axis direction of the optical system may be minimal.

When the object-side surfaces of the first, second, and third lenses (51, 52, and 53) each have a maximum effective length of CAiS1y and a minimum effective length of CAiS1x, the condition of the following equation may satisfy: 0.55<CAiS1x/CAiS1y <0.98. Here, i is 1, 2, or 3. When the sensor-side surfaces of the first, second, and third lenses 51 and 52 each have a maximum effective length of CAiS2y and a minimum effective length of CAiS2x, the condition of the following equation may satisfy: 0.55<CAiS2x/CAiS2y <0.98. Here, i is 1, or 2. Accordingly, the thickness of the portable device may not be increased in the high-resolution camera module.

The difference in the effective lengths of the first lens 51 and the fifth lens 55 can satisfy the following condition.
Condition: 0.55<CAnS2/CAlS1y <0.9

CAnS2 is the maximum effective length of the sensor-side surface of the n-th lens, and CAlS1y is the maximum effective length of the object-side surface of the first lens 51. This condition may be a condition for the first lens 51 having the largest effective length to be non-circular, and for example, the first lens 51 may be provided in a shape in which the effective length in the first direction X perpendicular to the optical axis is smaller than the effective length in the third direction Y. Accordingly, since the first lens 51 has a D-cut shape, the thickness of the camera module mounted in the thickness direction of the mobile terminal can be reduced. Here, if the last lens is the fifth lens 55, the following condition may satisfy: 0.55<CA5S2/CAlS1y <0.9. Preferably, 0.57<CA5S2/CAlS1y <0.9 or 0.6<CA5S2/CAlS1y <0.9 can be satisfied. If it is smaller than the range of the above conditions, the characteristics of RI (Relative illumination) and MTF (Modulation transfer function) may be deteriorated.

A first spacer 61 may be disposed around the object-side surface of the first lens 51. The first spacer 61 may be a light-blocking member, and the maximum length of an inner through hole in the first direction X may be smaller than the maximum length of the third direction Y. A second spacer 62 may be disposed around an outer perimeter between the first lens 51 and the second lens 52. The second spacer 62 may be a light-blocking member, and the maximum length of an inner through hole in the first direction X may be smaller than the maximum length of the third direction Y. A third spacer 63 may be disposed on the outer perimeter between the second lens 52 and the third lens 53. The third spacer 63 may be a light-blocking member, and the maximum length of the through hole in the first direction X may be smaller than the maximum length in the third direction Y.

A spacing member 64 may be disposed on the outer perimeter between the third lens 53 and the fourth lens 54, and the spacing member 64 may be a fourth spacer. That is, the spacing member 64 may be a spacer having the largest thickness among the spacers. The spacing member 64 may include a through hole 64A that penetrates from the upper surface S1 to the lower surface S2, and a reflective pattern 5 (See FIG. 6) arranged on the outer perimeter, i.e., the inner surface 64B, of the through hole 64A.

The spacing member 64 is a member that maintains a large gap between the two lenses, and the maximum length CA11 (See FIG. 6) of the inner through hole 64A in the first direction X may be smaller than the maximum length in the third direction Y. The upper portion of the through hole 64A of the spacing member 64 may have a circular shape having a first length CA11, and the lower portion may have a circular shape having a second length CA12. As another example, the upper portion of the spacing member 64 may have a non-circular shape having different lengths in the first and third directions, and in this case, the sensor-side surface of the third lens (103) may have a non-circular shape. The upper surface S1 or the lower surface S2 of the spacing member 64 may function as an aperture stop, or a separate aperture stop may be further disposed on the upper surface S1 or the lower surface S2. That is, the aperture stop may be disposed on the outer circumference between the third lens 53 and the fourth lens 54.

If the maximum length of the through hole of the first spacer 61 is H1S1y and the minimum length is H1S1x, the condition of the following equation may satisfy: 0.55<H1S1x/H1Sly <0.98. Here, if the value of the equation is less than 0.55, it is difficult to manufacture the through hole of the first spacer 61 into a non-circular shape and it is difficult to control the light passing through the lens, and if it exceeds 0.98, the size reduction in the third axis direction of the camera module can be minimal. If the maximum length of the through hole of the second spacer 62 is H2Sly and the minimum length is H2S1x, the condition of the following equation may satisfy: 0.55<H2S1x/H2Sly <0.98. Here, if the value of the equation is less than 0.55, it is difficult to manufacture the through hole of the second spacer 62 as a non-circular shape and it is difficult to control the light passing through the lens, and if it exceeds 0.98, the size reduction in the third axis direction of the camera module may be minimal. These configurations and conditions may also be applied to the third spacer. Accordingly, the thickness of the portable device may not be increased in the high-resolution camera module. As another example, if the sensor-side surface of the third lens 53 and the through hole 64A of the spacing member 64 are non-circular, the upper portion of the through hole 64A may have a maximum length of CA11y and a minimum length of CA11x, and the condition of the following equation may satisfy: 0.55<CA11x/CA11y <0.98.

A fifth spacer 65 may be arranged on the outer perimeter between the fourth lens 54 and the fifth lens 55. The fifth spacer 65 is a light-blocking member, and the internal through hole may be circular. The number of circular lenses among the plurality of lenses 125 may be equal to or smaller than the number of non-circular lenses. The number of spacers having a circular through hole may be equal to or smaller than the number of spacers having a non-circular shape. Here, the spacing member 64 may be included in the spacer.

The spacers 61, 62, 63, and 65 and the spacing member 64 may be made of the same material or different materials, and may be made of, for example, a material that absorbs light. The spacers 61, 62, 64, and 65 or/and the spacing member 64 may include a PE film (Poly Ethylene film) or a polyester (PET) film. As another example, the spacer 61, 62, 64, and 65 or/and the spacing member 64 may be a metal or an alloy having an oxide film formed on the surface thereof. The material included in the metal or alloy may include at least one of In, Ga, Zn, Sn, Al, Ca, Sr, Ba, W, U, Ni, Cu, Hg, Pb, Bi, Si, Ta, H, Fe, Co, Cr, Mn, Be, B, Mg, Nb, Mo, Cd, Sn, Zr, Sc, Ti, V, Eu, Gd, Er, Lu, Yb, Ru, Y, and La. The oxide film may be an oxide material treated with black oxide or brown oxide using copper.

Since one side or both sides of a lens having a relatively long effective length among the plurality of lenses 125 are cut and combined, the object-side opening 121A of the lens holder 121 in which the lenses are accommodated may have a length in the first direction X that is smaller than a length in the third direction Y. In addition, the object-side outer side S15 of the lens holder 121 may be provided as a flat surface or an inclined plane. In addition, both sides of the through holes having a relatively long effective length among the plurality of spacers in the first direction may be provided in a cut shape. For example, the through holes of the first to third spacers 61, 62, and 63 may have a non-circular shape.

The housing 1400 has a second opening 140 in a region corresponding to the sensor assembly 1300, and the lenses 125 and the image sensor 1303 may be opposed through the second opening 140. An optical filter 149 may be disposed on the second opening 140 of the housing 1400. The optical filter 149 may be disposed on the sensor-side surface of the second opening 140 of the housing 1400. As another example, the optical filter 149 may be disposed on the object-side surface of the second opening 140 of the housing 1400.

The optical filter 140 may be disposed between the plurality of lenses 125 and the image sensor 1303. The optical filter 140 may include at least one of an infrared filter and/or a cover glass. The optical filter 140 may pass light of a set wavelength band and filter light of a different wavelength band. When the optical filter 140 includes an infrared filter, it may block radiant heat emitted from external light from being transmitted to the image sensor 1303. In addition, the optical filter 140 can transmit visible light and reflect infrared rays.

The sensor assembly 1300 may include a circuit board 1301 and an image sensor 1303 disposed on one surface of the circuit board 1301. The circuit board 1301 may be electrically connected to a connector board 1350. The circuit board 1301 may be electrically connected to a driving portion and a hall sensor of the first and second lens assemblies 1100 and 1200. The image sensor 1303 may be opposed to the last lens of the plurality of lenses 125. The circuit board 1300 may include a circuit board having a wiring pattern that can be electrically connected, such as a rigid printed circuit board (Rigid PCB), a flexible printed circuit board (Flexible PCB), and a rigid flexible printed circuit board (Rigid Flexible PCB). The circuit board 1300 may be electrically connected to another camera module within the terminal or a processor of the terminal. Through this, the lens assembly described above and the camera device including the same may transmit and receive various signals within the terminal.

The center position of the second direction Z of the plurality of lenses 125 may be disposed closer to the reflective member 1132 than to the image sensor 1303. A distance BFL (Back focal length) in the optical axis direction Z between the last lens 55 of the plurality of lenses 125 and the image sensor 1303 may be 3 mm or more, and may be in the range of, for example, 3 mm to 15 mm or 5 mm to 10 mm. The BFL may be greater than or less than the maximum optical axis distance (TD: Total distance) between the plurality of lenses 125. The TD is an optical axis distance from the center of the object-side surface of the first lens to the center of the sensor-side surface of the last lens. The camera module may be provided as a folded camera module having a tele function by arranging the plurality of lenses 125 closer to the reflective member 1132 than the image sensor 1303.

The effective focal length (EFL) of the optical system having the plurality of lenses 125 may be greater than 7 mm and may satisfy the following conditions.
Condition: 7 mm<EFL <35 mm

Preferably, the condition of EFL may satisfy: 8 mm<EFL <30 mm or 9 mm<EFL<26 mm.

As shown in FIGS. 3, 5, and 6, the upper first length CA11 of the through hole 64A of the spacing member 64 may be longer than the lower second length CA12 in the first direction X. Accordingly, the effective regions of the object-side and sensor-side lenses of the spacing member 64 may be adjusted. The through hole 64A may satisfy the following conditions.
Condition: 0.6<CA12/CA11<0.9

The condition of the through hole 64A may be set by the effective region of the two adjacent lenses 53 and 54.

As shown in (A)(B) of FIG. 7, the spacing member 64 may have both sides in the short-axis direction cut or formed as flat surfaces DS1 and DS2, and both sides in the long-axis direction may be formed as convex curved surfaces. On the outer surface of the spacing member 64, the long-axis length is the length in the third direction, and the short-axis length is the length in the first direction. The short-axis length may be less than 100% of the long-axis length, for example, more than 57% and less than 100%.

As shown in FIG. 6, the outer side surface of the spacing member 64 may have an outer upper portion 64D protruding outward more than a lower portion 64C. The outer upper portion 64D of the spacing member 64 may be extended so that the upper surface S1 may stably contact the flange portion of the third lens 63. The lower surface S2 of the spacing member 64 may contact the object-side flange portion of the fourth lens 104.

The upper area of the through hole 64A of the spacing member 64 may be larger than the lower area. Accordingly, the inner surface 64B of the through hole 64A may be provided as a surface inclined with respect to the vertical axis. The inner surface 64B of the through hole 64A may include a reflective pattern 4 protruding in the direction of the optical axis. The reflective pattern 4 may include a pattern in which a plurality of circular or ring-shaped protrusions are arranged in the direction of the optical axis, and may include a concentric pattern in which the diameter gradually decreases from the upper portion of the through hole 64A to the lower portion. The reflective pattern 4 may be formed from an upper end to a lower end of the through hole 64A of the spacing member 64. Accordingly, the reflective pattern 4 may reflect light L10 incident through the lens not toward the image sensor 1303, as shown in FIG. 2 and FIG. 5, but in a different direction. Accordingly, the light path that is incident through an abnormal light path and then reflected by the inner surface 64B of the spacing member 64 and then proceeds to the image sensor 1303 is blocked, thereby blocking or suppressing a flare occurring on the image sensor 1303.

Here, the thickness TO of the spacing member 64 may correspond to the gap between the flanges of the third and fourth lenses 103 and 104, may be greater than 0.3 mm, and may be in the range of, for example, 0.3 mm<T0<2.8 mm. If the thickness TO of the spacing member 64 is smaller than the range, there is a problem that the TTL of the optical system decreases or the lenses may tilt, and if it is larger than the range, the TTL increases. The inclination angle R2 of the inner surface 64B of the spacing member 64 may be formed in a range of 5 degrees or more, for example, in a range of 5 degrees to 55 degrees or in a range of 10 degrees to 20 degrees. The outer angle R1 between the inner surface 64B and the upper surface S1 of the spacing member 64 may be 95 degrees or more, for example, in the range of 95 degrees to 145 degrees or in the range of 100 degrees to 110 degrees. If the inclination angle R2 of the inner surface 64B is smaller than the above-mentioned range, the light blocking efficiency may be reduced or flare may occur, and if it is larger than the above-mentioned range, effective light may be blocked.

A plurality of grooves 5 are included that are concave in a direction away from the optical axis between the plurality of reflective patterns 4, and the height of the region adjacent to the optical axis of the plurality of grooves 5 may be greater than the height of the inner bottom. Here, the height of the grooves 5 is an interval between the adjacent reflective patterns 5 in the direction of the optical axis. The bottom of each of the grooves 5 may be a concave curved surface or an angled surface. The shape of the grooves 5 may vary depending on the protruding shape of the reflective pattern 4. The pitch T2 between adjacent reflective patterns 4 may be constant and may be 0.05 mm or more, for example, in the range of 0.05 mm to 0.4 mm or 0.08 mm to 0.2 mm. If the pitch T2 between the reflective patterns 4 is smaller than the range, manufacturing is difficult and the flare improvement efficiency is insignificant, and if it is larger than the range, flare may occur. The pitch T2 between adjacent reflective patterns 4 may gradually narrow or gradually widen from the upper surface to the lower surface of the spacing member 64. The depth T1 of the groove 5 on the inner surface 64B may be constant or different in the circumferential direction and may be 0.05 mm or more, for example, in the range of 0.05 mm to 0.18 mm or 0.08 mm to 0.15 mm. The depth T1 of the groove 5 is a distance between the straight line connecting the bottoms of the grooves and the straight line connecting the reflective patterns 5. The depth T1 of the above groove 5 may have the same depth from the upper end to the lower end of the through hole 64A of the spacing member 64, or may have a lower depth as it goes down. If the depth T1 of the groove 5 is smaller than the above range, manufacturing may be difficult and flare may occur, and if it is larger than the above range, light path control may be difficult.

The pitch T2 of the reflective pattern 4, the depth T1 of the groove 5, and the thickness TO of the spacing member 64 may satisfy the following conditions.
Condition 1:0.04<T2/T0<0.3

Preferably, Condition 1 may satisfy: 0.08<T2/T1<0.15.
Condition 2:0.03<T1/T0<0.22

Preferably, condition 1 may satisfy: 0.06<T1/T0<0.11.

Here, the pitch T2 may be equal to or greater than the depth T1. The size of the internal reflective pattern 4 and groove 5 may be set based on the thickness TO of the spacing member 64 by the conditions 1 and 2, thereby increasing the flare improvement efficiency by the reflective pattern 4.

The internal angle R3 of each groove 5 between the reflective patterns 4 may be 30 degrees or more, for example, in the range of 33 degrees to 73 degrees, or in the range of 43 degrees to 63 degrees. The internal angle R3 of the groove 5 is the angle between the straight lines connecting the peaks of two adjacent reflective patterns and the low points of the groove 5. If the inner angle R3 of the groove 5 is smaller than the above range, the number of reflective patterns 4 increases or manufacturing is difficult, and if it is larger than the above range, flare may occur. In addition, each of the reflective patterns 4 includes a first inclined surface 4A and a second inclined surface 4B, and the first inclined surface 4A is an inclined surface close to the object, and the second inclined surface 4B is an opposite surface of the first inclined surface 4A. The first inclined surface 4A is a region that reflects incident light due to the inner angle R3 of the groove 5 and the inclined angle R2 of the inner surface 64B, and may be inclined at an acute angle based on straight lines in the first and third directions perpendicular to the optical axis. The boundary point between the first and second inclined surfaces 4A and 4B, that is, the vertex, may be a curved surface or a facet.

The reflective pattern 4 is formed on the inner surface 64B of the spacing member 64 having a relatively thick thickness, so that the light path traveling toward the inner surface 64B of the spacing member 64 can be reflected to a different path. In other words, the reflective pattern 4 can reflect the incident light in a direction other than the image sensor 1303, so that the flare intensity occurring within the image sensor 1303 may be reduced. As another example, the reflective pattern 4 may be formed as a rough surface. The rough surface may be formed by alternating convex and concave curves, so that the reflection efficiency of the incident light quantity can be improved.

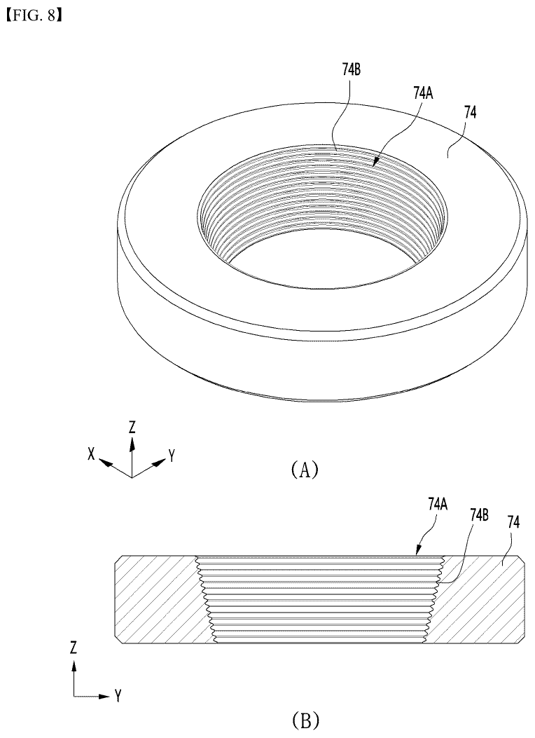

As shown in FIG. 8, the outer surface of the spacing member 74 has a cylindrical shape, and the inner through hole 74A may have an upper portion larger than a lower portion, so that it can have an inclined inner surface 74B. The inclined inner surface 74B may have the reflective pattern and grooves disclosed above. The spacing member 74 may have an upper surface area equal to a lower surface area.

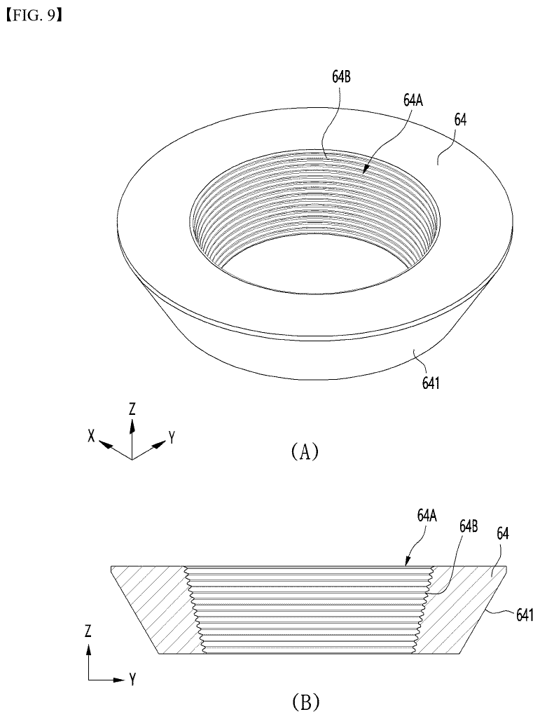

As shown in FIG. 9, the spacing member 64 may have an outer surface 641 shaped like a horn, and the inner through hole 64A may have an upper surface larger than a lower surface, so that it may have an inclined inner surface 64B. The inclined inner surface 64B may have the reflective pattern and grooves disclosed above. The spacing member 64 may have an upper surface area larger than a lower surface area.

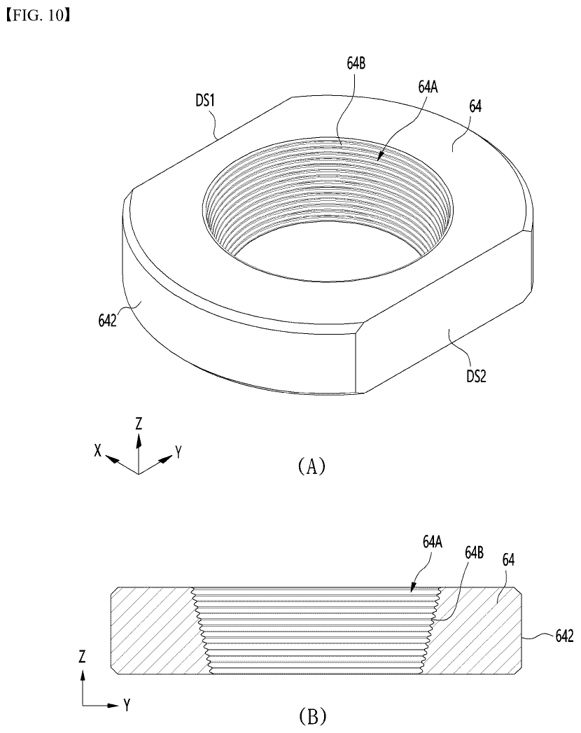

As shown in FIG. 10, the spacing member 64 is a shape with both sides cut off in the shape of a cylinder or a horn, and both sides DS1 and DS2 in the short-axis direction may be formed as vertical surfaces, and both sides in the long-axis direction can have a convex curved surface 642. The inner through hole 64A of the spacing member 64 may have a larger upper side than the lower side, and thus may have an inclined inner surface 64B. The inclined inner surface 64B may have the reflective pattern and grooves disclosed above. The upper surface area of the spacing member 64 may be the same as the lower surface area.

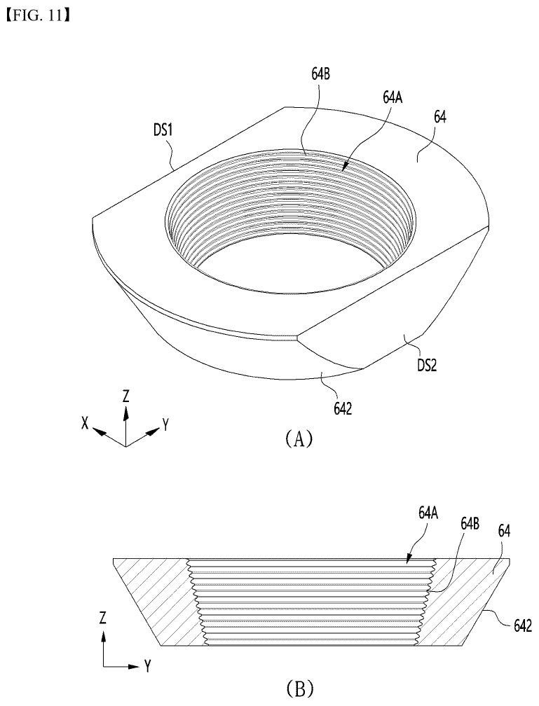

As shown in FIG. 11, the spacing member 64 is a shape in which both sides cut off in the shape of a cylindrical or horn, and both sides DS1 and DS2 in the short-axis direction can be formed as inclined surfaces, and both sides in the long-axis direction can have convex curves 642. The inner through hole 64A of the spacing member 64 may have an upper portion larger than a lower portion, and thus may have an inclined inner surface 64B. The inclined inner surface 64B may have the reflective pattern and grooves disclosed above. The spacing member 64 may have an upper surface area larger than a lower surface area.

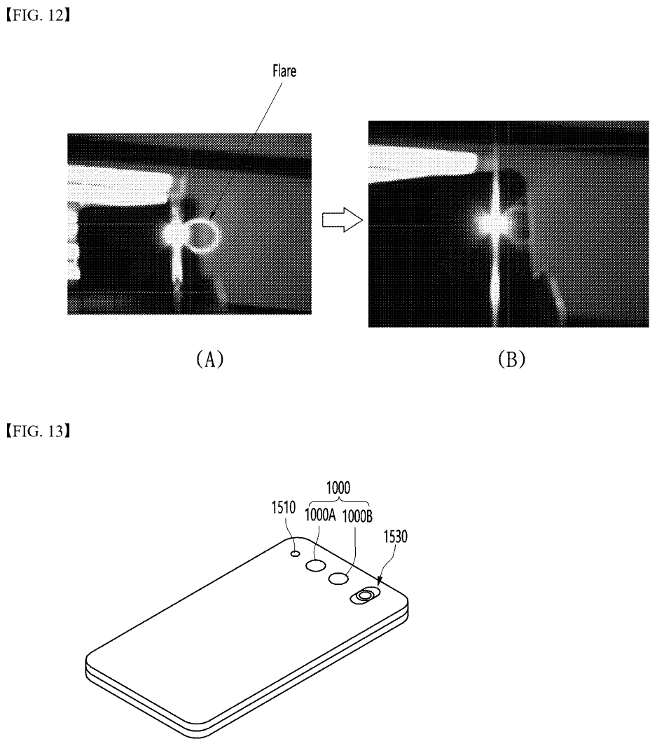

FIG. 12 is a drawing showing measurements of flare intensity of a comparative example (A) having a spacing member without a reflective pattern and an embodiment (B) having a spacing member with a reflective pattern. It can be seen that the embodiment of FIG. 12 (B) has a significantly lower or almost eliminated flare intensity compared to the comparative example (A).

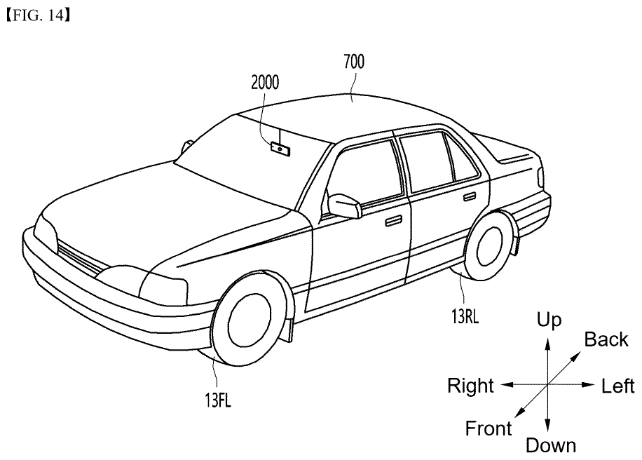

FIG. 13 is a perspective view of a mobile terminal to which a camera module according to an embodiment is applied.

As illustrated in FIG. 13, a mobile terminal 1500 of the embodiment may include a camera module 1000, a flash module 1530, and an autofocus device 1510 provided on the rear. The camera module 1000 may include an image capturing function and an autofocus function. For example, the camera module 1000 may include an autofocus function using an image. The camera module 1000 processes a still image or moving image frame obtained by an image sensor in a shooting mode or a video call mode. The processed image frame may be displayed on a predetermined display portion and stored in memory. A camera (not shown) can also be placed on the front of the mobile terminal body. For example, the camera module 1000 may include a first camera module 1000A and a second camera module 1000B, and OIS may be implemented together with an AF or zoom function by the first camera module 1000A.

The flash module 1530 may include a light emitting device that emits light inside. The flash module 1530 may be operated by the camera operation of the mobile terminal or the control of the user. The autofocus device 1510 may include one of the packages of surface-emitting laser elements as a light-emitting unit. The autofocus device 1510 may include an autofocus function using a laser. The autofocus device 1510 may be mainly used in conditions where the autofocus function using the image of the camera module 1000 is degraded, such as in a close range of 10 m or less or in a dark environment. The autofocus device 1510 may include a light-emitting portion including a vertical cavity surface-emitting laser (VCSEL) semiconductor element and a light-receiving portion that converts light energy into electric energy, such as a photodiode.

FIG. 14 is a perspective view of a vehicle to which a camera module according to an embodiment is applied. FIG. 14 is an exterior view of a vehicle equipped with a vehicle driving assistance device to which a camera module 1000 according to an embodiment is applied. Referring to FIG. 14, the vehicle 700 of the embodiment may be equipped with wheels 13FL and 13FR that rotate by a power source and a predetermined sensor.

The sensor may be a camera sensor 2000, but is not limited thereto. The camera 2000 may be a camera sensor to which a camera module 1000 according to the embodiment is applied. The vehicle 700 of the embodiment may obtain image information through the camera sensor 2000 that photographs a front image or a surrounding image, and may determine a lane non-identification situation using the image information and generate a virtual lane when the lane is not identified. For example, the camera sensor 2000 may photograph the front of the vehicle 700 to obtain a front image, and a processor (not shown) may analyze an object included in the front image to obtain image information. For example, if an object such as a center divider, curb, or street tree corresponding to a lane, an adjacent vehicle, an obstacle, or an indirect road sign is captured in an image captured by a camera sensor 2000, the processor can detect such an object and include it in the image information. At this time, the processor can obtain distance information from the object detected through the camera sensor 2000 to further supplement the image information. The image information may be information about the object captured in the image. The camera sensor 2000 may include an image sensor and an image processing module.

The camera sensor 2000 may process a still image or moving image obtained by an image sensor (e.g., CMOS or CCD). The image processing module may process a still image or moving image obtained through the image sensor, extract necessary information, and transmit the extracted information to the processor. At this time, the camera sensor 2000 may include a stereo camera to improve the measurement accuracy of the object and to secure more information such as the distance between the vehicle 700 and the object, but is not limited thereto. Although the above has been described with reference to examples, these are merely examples and do not limit the present invention. Those skilled in the art will appreciate that various modifications and applications not exemplified above are possible without departing from the essential characteristics of the present invention. For example, each component specifically shown in the examples may be modified and implemented. In addition, differences related to such modifications and applications should be interpreted as being included in the scope of the present invention defined in the appended claims.

14. A camera module comprising:
a reflective member that reflects light incident in a first direction in a second direction;
a lens holder having a plurality of lenses aligned along the second direction;
a circuit board having an image sensor that converts light refracted through the plurality of lenses into an electrical signal;
a plurality of spacers disposed on an outer periphery between two adjacent lenses; and
a spacing member having a largest thickness among the plurality of spacers,
wherein the spacing member includes a through hole extending from an upper surface to a lower surface and a plurality of reflective patterns arranged in a concentric shape along an inner surface of the through hole, and
wherein the plurality of reflective patterns has a plurality of protrusions arranged in the second direction.

15. The camera module of claim 14, wherein the through hole of the spacing member has an upper surface larger than a lower surface and an inner surface inclined at an angle of 5 degrees or more.

16. The camera module of claim 15, wherein an upper length of the through hole of the spacing member is CA11, a lower length is CA12, and
the following condition satisfies: 0.6<CA12/CA11<0.9.

17. The camera module of claim 14, comprises:
a plurality of grooves respectively disposed between the reflective patterns,
wherein a thickness of the spacing member is TO,
wherein a depth of the groove is T1, and
wherein the following condition satisfies: 0.03<T1/T0<0.22.

18. The camera module of claim 17, wherein a pitch between the reflective patterns is T2, and
wherein the following condition satisfies: 0.04<T2/T0<0.3.

19. The camera module of claim 14, wherein an outer surface of the spacing member has different lengths in the first direction and a third direction orthogonal to the second direction, which is an optical axis of the plurality of lenses.

20. The camera module of claim 14, wherein a thickness of the spacing member is TO, and
wherein the following condition satisfies: 0.3 mm<T0<2.8 mm.

21. The camera module of claim 14, wherein an object-side surface or a sensor-side surface of at least one lens adjacent to an object among the plurality of lenses has a non-circular shape in which effective lengths in two directions orthogonal to the optical axis of the plurality of lenses are different from each other.

22. The camera module of claim 21, wherein a first lens closest to the object among the plurality of lenses includes an object-side surface and a sensor-side surface, and a maximum effective length of the object-side surface is CAlS1y, a minimum effective length is CAlS1x, and
wherein the following equation satisfies: 0.55<CAlS1x/CAlS1y <0.98.

23. The camera module of claim 22, wherein a maximum effective length of the sensor-side surface of the first lens is CAlS2y, a minimum effective length is CAlS2x, and
wherein the following equation satisfies: 0.55<CAlS2x/CAlS2y <0.98.

24. The camera module of claim 21, wherein an outer peripheral surface of the lens holder includes regions in which two directions perpendicular to the optical axis have different lengths.

25. The camera module of claim 21, wherein a sensor-side surface of a lens located on the object side of the spacing member is a circular shape.

26. An electronic device having the camera module of claim 14.

27. The camera module of claim 14, wherein an upper surface area of the spacing member is larger than a lower surface area, and
wherein the protrusions of the plurality of reflective patterns have concentric shapes with diameters gradually decreasing from an upper portion to a lower portion of the through hole.

28. The camera module of claim 14, wherein the protrusions of the plurality of reflective patterns have a circular shape or a ring shape.

29. The camera module of claim 14, wherein at least one of through holes of the plurality of spacers has a non-circular shape.

30. The camera module of claim 14, wherein an outer upper portion of the spacing member protrudes outward more than an outer lower portion.

31. The camera module of claim 30, wherein an upper surface of the outer upper portion of the spacing member and a lower surface of the outer lower portion are in contact with flange portions of lenses arranged on both sides of the spacing member.

32. The camera module of claim 14, wherein an internal angle of a groove disposed between adjacent reflective patterns is an angle between straight lines connecting peaks of two adjacent reflective patterns and a low point of the groove, and is in a range of 33 to 73 degrees.

33. A camera module comprising:
a lens holder having a plurality of lenses aligned along an optical axis;
a circuit board having an image sensor disposed to convert light refracted through the plurality of lenses into an electrical signal;
a plurality of spacers disposed on an outer periphery between the two adjacent lenses; and
a spacing member having a largest thickness among the plurality of spacers,
wherein the spacing member includes a through hole extending from an upper surface to a lower surface and a plurality of reflective patterns arranged in a concentric shape along an inner surface of the through hole, and
wherein the plurality of reflective patterns has a plurality of protrusions arranged in a direction of the optical axis.
